(19) United States
(12) Patent Application Publication
(10) Pub. No.: US 2025/0046905 A1
(43) Pub. Date: Feb. 6, 2025

(54) Temperature Control Device for an Electrified Motor Vehicle With a Cooling Device and a Heating Device

(71) Applicant: Bayerische Motoren Werke Aktiengesellschaft, Muenchen (DE)

(72) Inventors: Stefan HOFMANNINGER, Weibern (AT); Alexander LICHTENBERGER, St. Peter in der Au (AT)

(21) Appl. No.: 18/718,267

(22) PCT Filed: Feb. 27, 2023
(86) PCT No.: PCT/EP2023/054774

§ 371 Date: Jun. 10, 2024

(30) Foreign Application Priority Data
Mar. 22, 2022 (DE) 10 2022 106 635.5

(51) Int. Cl. H01M 10/625; B60L 58/26; B60L 58/27; H01M 10/613; H01M 10/615; H01M 10/656; H01M 10/6571

(52) U.S. Cl. CPC H01M 10/625; B60L 58/26; B60L 58/27; H01M 10/613; H01M 10/615; H01M 10/656; H01M 10/6571; H01M 2220/20

(57) ABSTRACT

A temperature control device for controlling temperature of vehicle components includes a cooling device for cooling a vehicle component to be cooled with a plate heat exchanger that flows through two heat transport medium streams and transfers waste heat of the vehicle component to be cooled, transported by one heat transport medium stream to the other stream, and includes a heating device for heating a vehicle component to be heated, wherein the temperature control device is a structural unit with the plate heat exchanger and the heating device by a heating surface having a heating element, arranged on and/or in a plate pack of the plate heat exchanger and being configured to release heat to the heat transport medium stream flowing through the plate heat exchanger and to the vehicle component to be heated.

### BACKGROUND AND SUMMARY

The invention relates to a temperature control apparatus for a temperature control system, designed for the temperature control of vehicle components, of an electrified motor vehicle. The temperature control apparatus comprises a cooling device for cooling a vehicle component to be cooled with a plate heat exchanger which can be flowed through by two heat transport medium flows of the temperature control system and is designed to transfer exhaust heat, transported by the one heat transport medium flow, of the vehicle component to be cooled to the other heat transport medium flow. Moreover, the temperature control system comprises a heating device for heating a vehicle component to be heated.

In the present case, interest focuses on temperature control systems for electrified motor vehicles, that is to say hybrid vehicles or electric vehicles. Electrified motor vehicles have an electric drive train which usually comprises at least one electric traction machine or drive machine, a rechargeable traction battery, for example a high-voltage energy store, for the supply of the electric drive machine, and various electronics components. Here, the temperature control system serves to carry out various temperature control tasks in the motor vehicle, that is to say the feed or discharge of heat to/from various vehicle components, in order to ensure optimum operation of the motor vehicle.

For the temperature control, that is to say for the needs-based heating and cooling, of a vehicle component, the latter is usually incorporated into at least one temperature control circuit, conducting a heat transport medium, of the temperature control system of the motor vehicle. This circuit has, for example, a plate heat exchanger for cooling and an electric supplementary heater, for example an electric continuous flow heater, for heating. A supplementary heater of this type is an additional component and therefore increases the costs and the installation space requirement of the temperature control system in the motor vehicle. It is also already known to use a power loss of other vehicle components in order to heat a vehicle component. This is often inefficient, however.

It is an object of the present invention to provide a solution, by means of which vehicle components of an electrified motor vehicle can be temperature-controlled efficiently and inexpensively.

According to the invention, this object is achieved by way of a temperature control apparatus and a temperature control system with the features according to the present disclosure. Advantageous embodiments of the invention are also the subject matter of the description and the figures.

A temperature control apparatus according to the invention for a temperature control system, designed for the temperature control of vehicle components, of an electrified motor vehicle comprises a cooling device for cooling a vehicle component to be cooled with a plate heat exchanger which can be flowed through by two heat transport medium flows of the temperature control system. The plate heat exchanger is designed to transfer exhaust heat, transported by the one heat transport medium flow, of the vehicle component to be cooled to the other heat transport medium flow. Moreover, the temperature control apparatus comprises a heating device for heating a vehicle component to be heated. The temperature control apparatus is configured as one structural unit consisting of the plate heat exchanger and the heating device, by at least one heating surface, having a heating element, of the heating device being arranged on and/or in a plate package of the plate heat exchanger. In order to heat the vehicle component to be heated, the at least one heating surface is designed to output heat at least to the heat transport medium flow which flows through the plate heat exchanger and flows to the vehicle component to be heated.

Moreover, the invention relates to a temperature control system for an electrified motor vehicle comprising at least one vehicle component and at least one temperature control apparatus according to the invention. The motor vehicle comprises, in particular, a multiplicity of vehicle components to be temperature-controlled, for example a traction battery, an electric drive machine, electronics components, for example control units, a passenger compartment, etc., which are incorporated into the temperature control system. The temperature control system can comprise a plurality of temperature control circuits, in which in each case one heat transport medium flow is conducted, it being possible for the temperature control circuits to be coupled or to be capable of being coupled thermally. In order to conduct and convey the heat transport medium flows, the temperature control circuits can comprise temperature control lines and pumps. Controllable actuators or valves can be provided in order to fluidically couple the temperature control circuits. Moreover, temperature control apparatuses can be incorporated into the temperature control circuits of the temperature control system for temperature control of the vehicle components. The temperature control apparatuses, valves and pumps can be actuated, for example, by a control device of the temperature control system.

At least one of the temperature control apparatuses comprises, for cooling, the cooling device with the plate heat exchanger which is designed to transfer heat between two heat transport medium flows which flow through the plate package of the plate heat exchanger. The heat transport media of the heat transport medium flows can be, for example, coolant. It can also be the case, however, that the heat transport medium of one heat transport medium flow is a coolant, and the heat transport medium of the other heat transport medium flow is a refrigerant. In this case, the plate heat exchanger of the cooling device is configured as a chiller, in the case of which heat is transferred from the coolant flow to the refrigerant flow.

The plate package or the plate stack comprises a plurality of plates arranged in parallel with alternating seal patterns which are specific to the heat transport medium flow. An intermediate space which is specific to the heat transport medium flow or a flow chamber which is specific to the heat transport medium flow is configured in each case between two plates. This means that the heat transport medium of that heat transport medium flow flows in each intermediate space which is specified by way of the seal pattern, which is specific to the heat transport medium flow, of an adjacent plate. The heat transport media of the heat transport medium flows flow here in an alternating manner and, for example, in opposite flow directions with respect to one another through the plate package. In order to feed in and discharge the heat transport medium flows, moreover, the plate heat exchanger has fluid connectors which are specific to the heat transport medium flow and can be coupled to the temperature control lines.

Moreover, the temperature control apparatus comprises the heating device which is designed to output heating energy or heat to at least one of the heat transport medium flows, with the result that this heat transport medium flow transports the heat to the vehicle component to be heated. Here, the heating device is integrated into the plate heat exchanger, with the result that the structural, constructional unit is produced. The structural unit is, in particular, a single-part construction, by way of which a multi-functional component for heating and cooling vehicle components as required is produced. To this end, the plate package of the plate heat exchanger and the at least one heating surface of the heating device are arranged, for example, in a common housing of the temperature control apparatus. The heating device is, in particular, installed fixedly on the plate heat exchanger, with the result that the heating energy can be output directly to the heat transport medium flow which flows through the plate package. By way of the plate heat exchanger being connected to at least one temperature control circuit, the heating device is also connected to the at least one temperature control circuit. The cooling device can comprise further components, for example, in the case of the chiller, an expansion valve and an electric refrigerant compressor which can likewise be integrated into the structural unit or can be coupled to the latter.

In order to integrate the heating device into the plate heat exchanger, the at least one heating surface is arranged in or on the plate package. The at least one heating surface comprises a heating element. The heating element of the at least one heating surface is, in particular, an electric heating element and has electric connectors which can be connected to a power supply controllably, for example via switching elements. For example, the fluid connectors and the electric connectors of the temperature control apparatus can be arranged on different housing walls of the housing. For example, the housing wall with the fluid connectors is oriented parallel to the plates of the plate package, and the housing wall with the electric connectors is oriented perpendicularly with respect to the plates of the plate package. In the case of the heating device being integrated into a chiller, there is the advantage that there is already an electric attachment for the refrigerant compressor which is integrated into the chiller or is connected to the chiller, which electric attachment can also be used for the power supply of the heating device.

Here, the at least one heating surface extends, in particular, parallel to at least one plate of the plate heat exchanger, and has, in particular, at least 50% of the surface area of the plate. As a result of this great heat transfer surface area of the heating surface, the heating device is of particularly efficient design. Here, the at least one heating surface is arranged on or in the plate package in such a way that the heating energy is output to that heat transport medium flow which leads to the vehicle component to be heated.

For example, the at least one heating surface is arranged so as to bear against or in at least one plate of the plate package. A plurality of plates of the plate package can also be fitted with in each case one heating surface. For example, the heating surfaces can be arranged on or in the surface of the plates. In the case where the heating surface is arranged on a surface of the plate and, in particular, is connected mechanically, for example adhesively bonded, to this surface, it outputs the heat energy directly to the heat transport medium which is flowing past. In the case where the heating surface is arranged within the plate, it outputs the heat in the manner of a panel heater by the surface of the plate to the heat transport medium which is flowing past.

It can also be provided that the at least one heating surface is arranged on or in a support plate which is arranged in an intermediate space between two plates of the plate package. For example, a plurality of support plates with heating surfaces can be provided which are pushed into the intermediate spaces and are flowed around by the respective heat transport medium.

The heating device can be activated by the control device in order to output the heating energy to the heat transport medium flow, for example by the control device connecting the electric connectors to the power supply by way of actuation of the switching elements. By virtue of the fact that the heating device is connected via the plate package of the plate heat exchanger to at least one temperature control circuit which conducts heat transport medium, the heating energy is output via the at least one plate of the plate package or directly to the at least one heat transport medium flow and is transported further through the temperature control lines. The control device can control the heat transport medium flow in the temperature control circuit in order to transport the heating energy to the vehicle component. To this end, for example, the control device can activate a corresponding pump for conveying the heat transport medium and can possibly actuate certain actuators or valves, in order to fluidically connect the vehicle component in series to the structural unit.

A heating device of this type which is integrated into the plate heat exchanger has particularly high efficiency. As a result of the satisfactory thermal coupling between the heat transport medium and the heating device via the plate package, an additional heater which is intensive in terms of costs and installation space, for example an electric continuous flow heater, can advantageously be dispensed with in the temperature control circuit. As a result, installation space and costs can be saved by way of the compact, structural unit.

The heating surface has, in particular, a flat carrier, on which the heating element is arranged or into which the heating element is integrated. For example, the flat carrier is configured as a foil, with the result that the heating surface is configured as a heating foil. The heating element can have, for example, a meandering electric conductor which is embedded into the foil and which has electric connectors for energizing. A heating foil of this type is particularly inexpensive and, in comparison with an electric continuous flow heater, has a particularly low weight, with the result that, moreover, the temperature control apparatus is of particularly weight-saving configuration.

It proves to be advantageous if the heating element of the at least one heating surface is a self-regulating heating element. A heating element of this type is configured, in particular, as a thermistor or PTC resistor. In the case of heating elements of this type, an inherent resistance increases as the temperature rises, and the current conductivity and the power output drop. On account of this self-regulating property, heating elements of this type do not overheat, with the result that the temperature control apparatus is of particularly safe and reliable configuration.

The temperature control apparatus is preferably configured to heat and cool the same vehicle component, in particular the traction battery, which can have a heating requirement at low external temperatures and a cooling requirement at high external temperatures for optimum functional efficiency. To this end, the temperature control apparatus can be incorporated into that temperature control circuit of the temperature control system which conducts the first heat transport medium flow and in which the vehicle component to be temperature-controlled is also arranged. The plate heat exchanger for cooling the vehicle component is designed to transfer the exhaust heat of the vehicle component from the first heat transport medium flow to the second heat transport medium flow. The heating device for heating the vehicle component is designed to output heat to the first heat transport medium flow.

In order to cool the vehicle component, the exhaust heat is transported via the first heat transport medium flow from the vehicle component to the plate heat exchanger and, in order to heat the vehicle component, the heating warmth is transported via the first heat transport medium flow from the heating device which is integrated into the plate heat exchanger to the vehicle component. In the case of a temperature control circuit, into which the traction battery and the chiller are incorporated, the chiller is designed, in the case of a cooling requirement of the traction battery, to output the exhaust heat, transported via the coolant flow to the chiller, of the traction battery to the refrigerant flow and therefore to transport it away from the cooling circuit of the traction battery. In the case of a heating requirement of the traction battery, the heating device is designed to output heat to the coolant flow, with the result that the latter transports the heat to the traction battery.

The embodiments proposed in relation to the temperature control apparatus according to the invention and their advantages apply correspondingly to the temperature control system according to the invention.

Further features of the invention result from the claims, the figures and the description of the figures. The features and combinations of features mentioned above in the description and the features and combinations of features mentioned below in the description of the figures and/or shown solely in the figures can be used not only in the respective specified combination, but rather also in other combinations or on their own.

The invention will now be explained in greater detail on the basis of one preferred exemplary embodiment and with reference to the drawings.

### BRIEF DESCRIPTION OF THE DRAWINGS

FIG. 1 shows a diagrammatic illustration of a temperature control apparatus,

FIGS. 2a and 2b show the temperature control apparatus with different heat transport medium flows,

FIG. 3 shows a diagrammatic illustration of a first embodiment of a plate heat exchanger of the temperature control apparatus,

FIG. 4 shows a diagrammatic illustration of a second embodiment of a plate heat exchanger of the temperature control apparatus,

FIG. 5 shows a diagrammatic illustration of a first embodiment of the temperature control apparatus,

FIG. 6 shows a diagrammatic illustration of a plate with a heating surface of the temperature control apparatus according to FIG. 5,

FIG. 7 shows a diagrammatic illustration of a second embodiment of the temperature control apparatus, and

FIG. 8 shows a diagrammatic illustration of a support plate with a heating surface of the temperature control apparatus according to FIG. 7.

### DETAILED DESCRIPTION OF THE DRAWINGS

In the figures, identical and functionally identical elements are provided with the same designations.

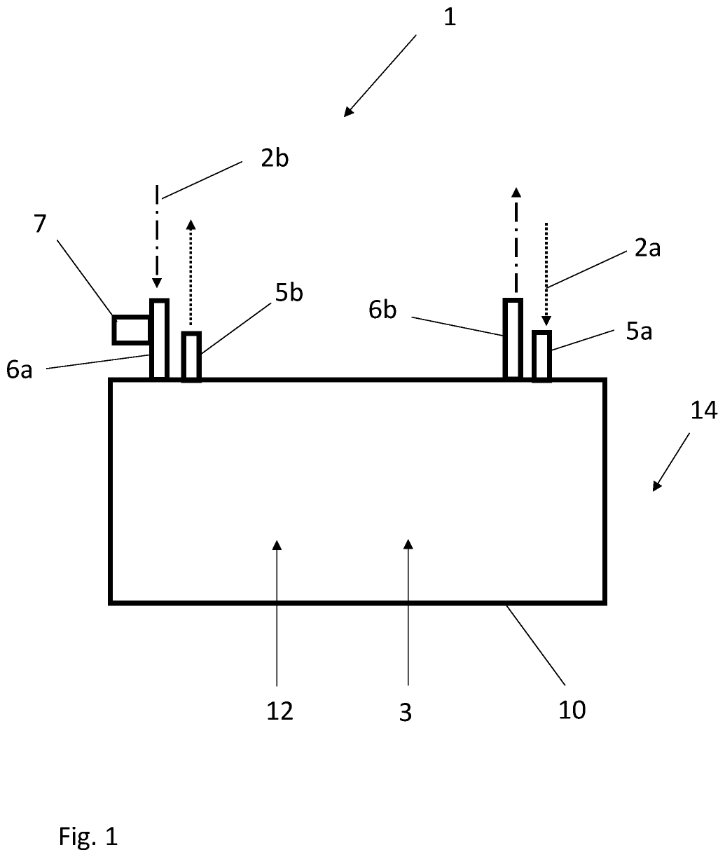

FIG. 1 shows a diagrammatic illustration of a temperature control apparatus 1 which is designed for the temperature control, that is to say for cooling and for heating as required, of vehicle components of an electrified motor vehicle. To this end, the temperature control apparatus 1 and the vehicle components are incorporated into at least one temperature control circuit, conducting heat transport medium, of a temperature control system of a motor vehicle. The temperature control apparatus 1 can be designed, for example, to control the temperature of a vehicle component in the form of a traction battery of the motor vehicle, and can be arranged with the traction battery in a temperature control circuit in the form of a cooling circuit which conducts a first heat transport medium flow 2a in the form of a coolant flow.

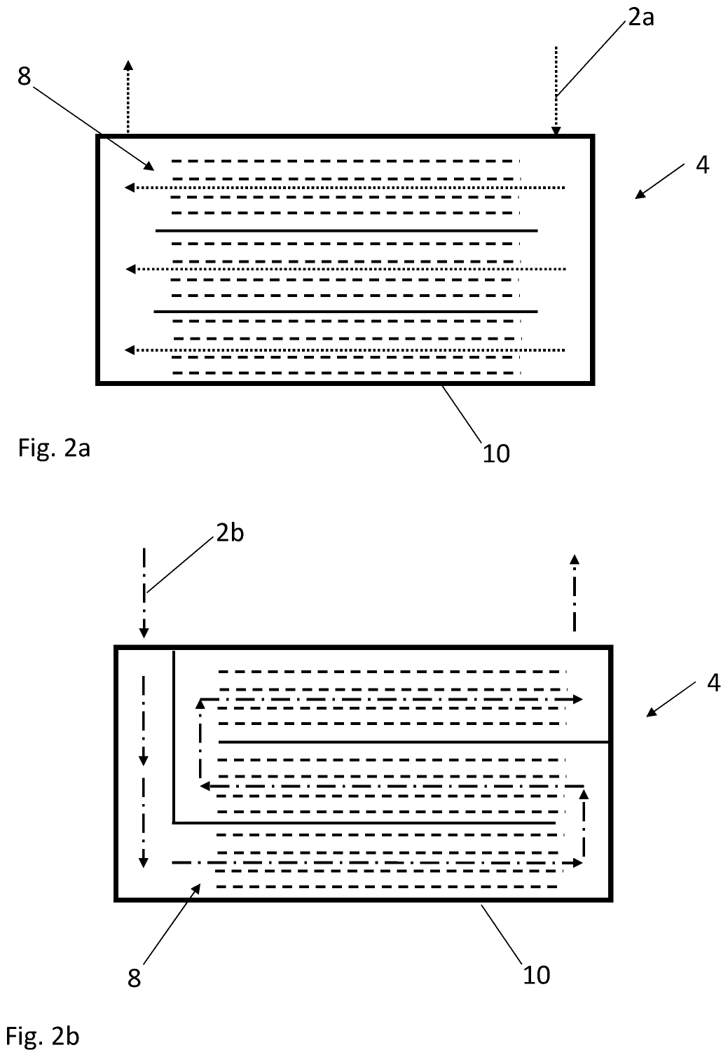

In order to cool the vehicle component, it outputs its exhaust heat to the first heat transport medium flow 2a which is conducted in the temperature control circuit, is guided to the temperature control apparatus 1, and flows through the temperature control apparatus 1, as shown in FIG. 2a. There, the exhaust heat is transferred to a second heat transport medium flow 2b which likewise flows through the temperature control apparatus 1, as shown in FIG. 2b. The second heat transport medium flow 2b can be, for example, a further coolant flow in the form of a liquid or gas flow or a refrigerant flow of a refrigerant circuit, to which the temperature control apparatus 1 is likewise connected.

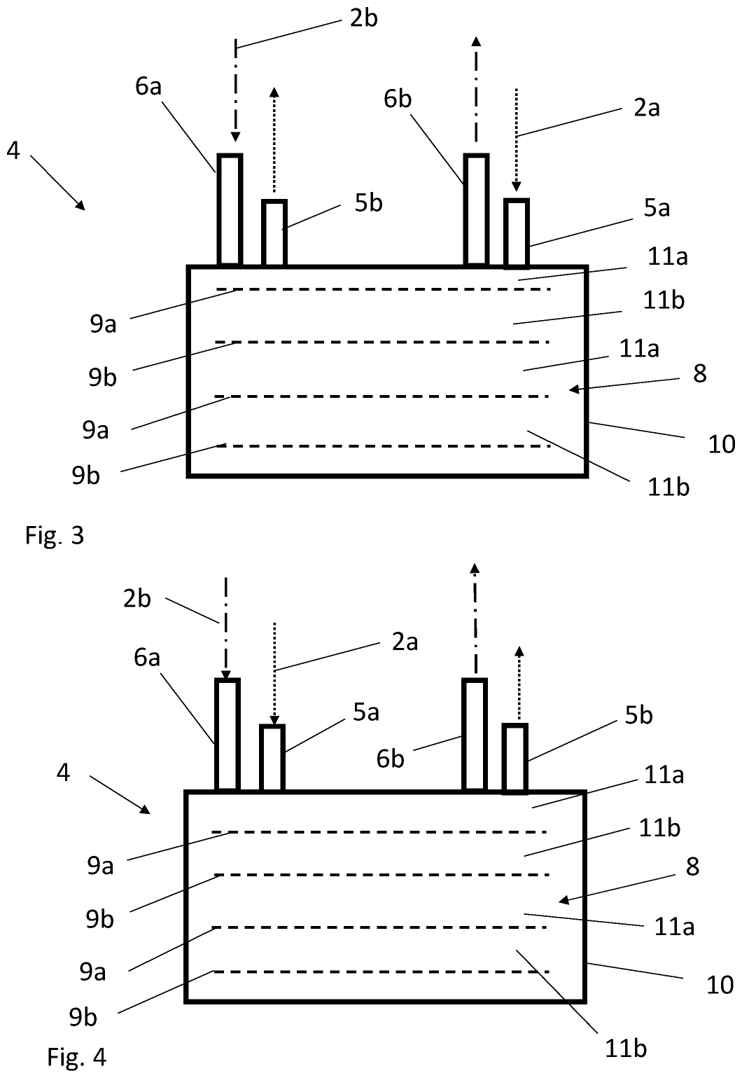

In order to dissipate the exhaust heat, the temperature control apparatus 1 has a cooling device 3 with a plate heat exchanger 4 (shown in FIG. 3 and FIG. 4). The plate heat exchanger 4 has first fluid connectors 5a, 5b for feeding in and discharging the heat transport medium of the first heat transport medium flow 2a, and second fluid connectors 6a, 6b for feeding in and discharging the heat transport medium of the second heat transport medium flow 2b. Here, the fluid connectors 5a, 6a are fluid inlets, and the fluid connectors 5b, 6b are fluid outlets. In the case where the first heat transport medium flow 2a is a coolant flow and the second heat transport medium flow 2b is a refrigerant flow, the plate heat exchanger 4 is configured as a chiller. In the case where the chiller is configured to cool the traction battery, the chiller is connected to the coolant circuit of the traction battery and to the refrigerant circuit which conducts a refrigerant and is coupled thermally, for example, to a temperature control circuit for a passenger compartment of the motor vehicle. Here, moreover, the cooling device 3 has an expansion valve 7 which is coupled to the second fluid inlet 6a for the refrigerant.

The plate heat exchanger 4 has a plate package 8 consisting of stacked plates 9a, 9b. The plate package 8 is arranged in a housing 10 of the cooling device 3, which housing 10 configures, moreover, a housing 10 of the temperature control apparatus 1. The plates 9a and 9b are stacked in an alternating manner here and have a seal pattern which is specific for heat transport medium. Here, the first plates 9a have a first seal pattern, by way of which heat transport medium of the first heat transport medium flow 2a is conducted in a respective first intermediate space 11a or chamber which adjoins the first plates 9a. The second plates 9b have a second seal pattern, by way of which heat transport medium of the second heat transport medium flow 2b is conducted in a respective second intermediate space 11b or chamber which adjoins the second plates 9b. Here, the first intermediate spaces 11a are coupled fluidically to the first fluid connectors 5a, 5b, and the second intermediate spaces 11b are coupled fluidically to the second fluid connectors 6a, 6b. The first and second intermediate spaces 11a, 11b are sealed with respect to one another. As a result of the alternating arrangement of the plates 9a, 9b and the intermediate spaces 11a, 11b, the first and the second heat transport medium flow 2a, 2b thus flow in an alternating manner past one another through the plate package 8 and transfer heat in the process. FIG. 3 shows a plate heat exchanger 4 in accordance with the counterflow principle, in the case of which the heat transport medium flows 2a, 2b flow past one another in an opposed direction. FIG. 4 shows a plate heat exchanger 4 in accordance with the uniflow principle, in the case of which the heat transport medium flows 2a, 2b flow past one another in the same direction. Although the first heat transport medium flow 2a and the second heat transport medium flow 2b are therefore decoupled fluidically, they are coupled thermally. In the case of the chiller, heat is transferred from the coolant flow 2a to the coolant flow 2b.

In order to heat the vehicle component, moreover, the temperature control apparatus 1 comprises a heating device 12 which is designed to transfer heat to at least one of the heat transport medium flows 2a, 2b. In the case of the temperature control apparatus 1 which is provided for the temperature control of the traction battery, the heating device 12 can transfer heat to the first heat transport medium flow 2a in the form of the coolant flow, which heat is conducted by the first heat transport medium flow 2a to the traction battery.

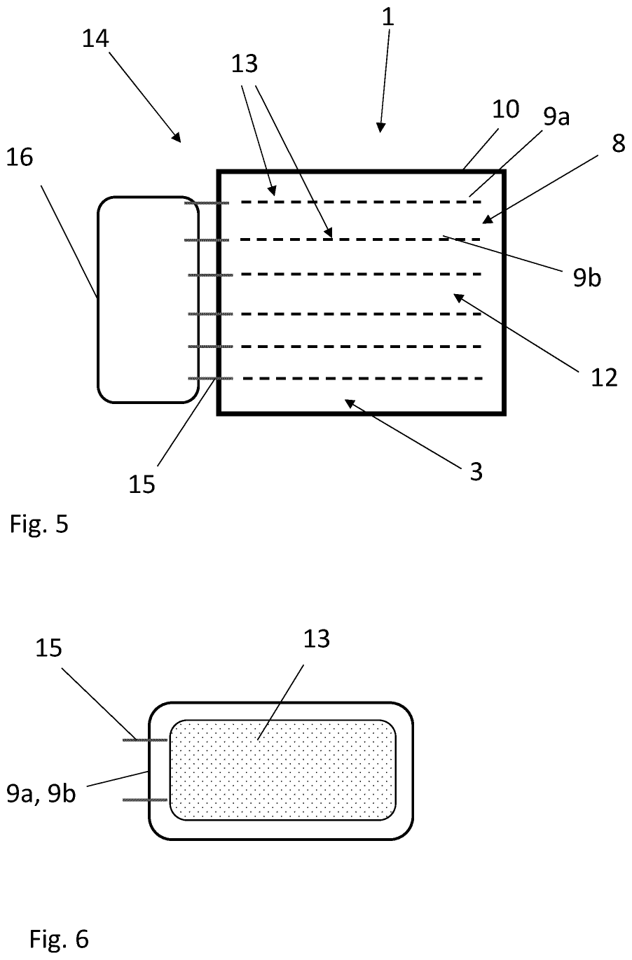

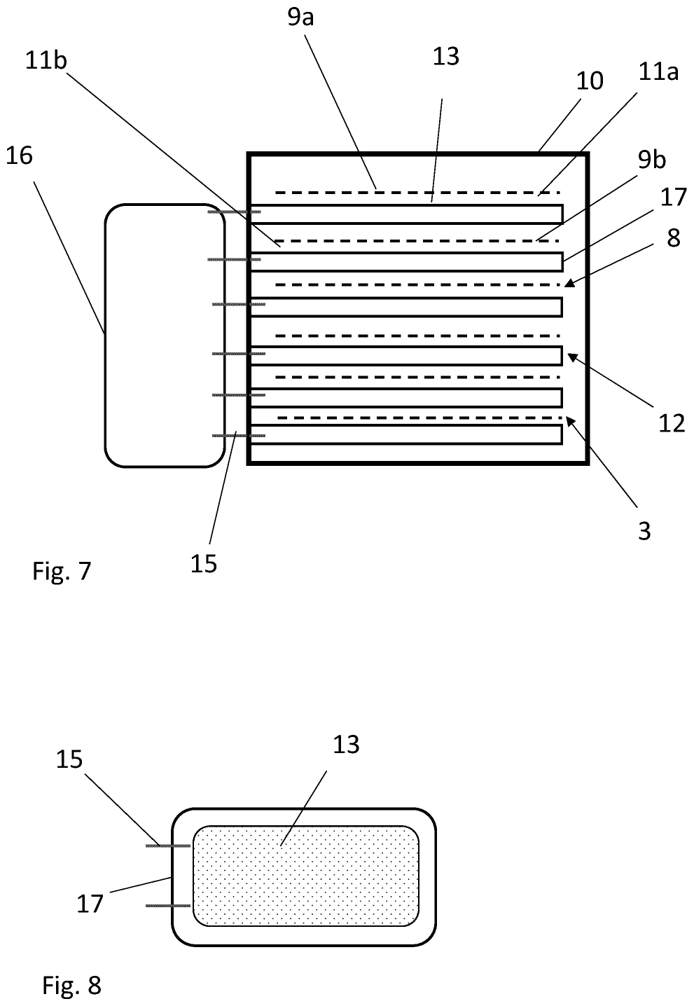

Here, as shown in FIG. 5 and FIG. 7, the heating device 12 is integrated into the plate heat exchanger 4, by at least one heating surface 13 of the heating device 12 being arranged in or on the plate package 8. The heating surfaces 13 are therefore likewise arranged within the housing 10, with the result that the cooling device 3 and the heating device 12 configure one structural unit 14. The heating surfaces 13 have a flat carrier, for example a foil, and an electric heating element which is arranged on the carrier or is integrated into the carrier. The electric heating elements 13 are connected to electric connectors 15 which can be coupled to a control device 16 for activating the heating device 12.

According to FIG. 5, the heating surfaces 13 are integrated into the plate package 8 in such a way that in each case one heating surface 13 is arranged on a plate 9a, 9b of the plate package 8 here. Therefore, as shown in FIG. 6, the plates 9a, 9b act as carrier for the heating surfaces 13. When the heat transport medium of the respective heat transport medium flow 2a, 2b then flows past the respective plate 9a, 9b, it also flows past the heating surfaces 13 which, as a result, output their heating warmth directly to the respective heat transport medium flow 2a, 2b. According to FIG. 5, the heating surfaces 13 are integrated into the plate package 8 in such a way that, as shown in FIG. 8, they are arranged on support plates 17 which are pushed into the intermediate spaces 11a, 11b. When the heat transport medium of the respective heat transport medium flow 2a, 2b then flows through the respective intermediate space 11a, 11b, it also flows around the support plates 17 with the heating surfaces 13 which, as a result, output their heating warmth directly to the respective heat transport medium flow 2a, 2b.

1-14. (canceled)

15. A temperature control apparatus for a temperature control system, configured for temperature control of vehicle components of an electrified motor vehicle, the temperature control apparatus comprising:
a cooling device configured to cool a vehicle component to be cooled with a plate heat exchanger that is configured to be flowed through by at least two heat transport medium flows of the temperature control system and is configured to transfer exhaust heat, transported by a first heat transport medium flow, of the vehicle component to be cooled to a second heat transport medium flow; and
a heating device configured to heat a vehicle component to be heated;
wherein the temperature control apparatus is configured as one structural unit with the plate heat exchanger and the heating device, by at least one heating surface, having a heating element, of the heating device being arranged on and/or in a plate package of the plate heat exchanger and being configured to output heat at least to the first heat transport medium flow which flows through the plate heat exchanger and flows to the vehicle component to be heated.

16. The temperature control apparatus according to claim 15,
wherein the temperature control apparatus is configured to arrange, in a temperature control circuit of the temperature control system, flowed through by the first heat transport medium flow, and configured to control a temperature of at least one vehicle component that is arranged in the same temperature control circuit, the plate heat exchanger for cooling the vehicle component being configured to transfer exhaust heat of the vehicle component from the first heat transport medium flow to the second heat transport medium flow, and the heating device configured to heat the at least one vehicle component and configured to output heat to the first heat transport medium flow.

17. The temperature control apparatus according to claim 15,
wherein the heating element of the at least one heating surface is a self-regulating, electric heating element.

18. The temperature control apparatus according to claim 15,
wherein the at least one heating surface comprises a flat carrier, on which the heating element is arranged or into which the heating element is integrated.

19. The temperature control apparatus according to claim 18,
wherein the flat carrier is configured as a foil, and wherein the at least one heating surface is configured as a heating foil.

20. The temperature control apparatus according to claim 15,
wherein the at least one heating surface is arranged so as to bear against or in at least one plate of the plate package.

21. The temperature control apparatus according to claim 15,
wherein the at least one heating surface is arranged on or in a support plate which is arranged in an intermediate space between two plates of the plate package.

22. The temperature control apparatus according to claim 15,
wherein the plate heat exchanger is configured as a chiller configured to conduct a coolant flow as the first heat transport medium flow and a refrigerant flow as the second heat transport medium flow.

23. The temperature control apparatus according to claim 22,
wherein the heating device is configured to output heat at least to the coolant flow of the chiller.

24. The temperature control apparatus according to claim 15,
wherein the temperature control apparatus comprises a housing in which the plate package and the at least one heating surface are arranged.

25. The temperature control apparatus according to claim 24,
wherein fluid connectors for feeding in and discharging heat transport medium are arranged on a first housing wall of the housing, and electrical connectors for contacting the at least one heating element are arranged on a second housing wall of the housing.

26. A temperature control system for a motor vehicle comprising:
at least one vehicle component; and
the temperature control apparatus according to claim 15.

27. The temperature control system according to claim 25, comprising:
a temperature control circuit configured to conduct the first heat transport medium flow, into which temperature control circuit the temperature control apparatus and the vehicle component are incorporated,
wherein the plate heat exchanger for cooling the vehicle component is configured to transfer exhaust heat of the vehicle component from the first heat transport medium flow to the second heat transport medium flow, and
wherein the heating device is configured to heat the vehicle component being configured to output heat to the first heat transport medium flow.

28. The temperature control system according to claim 27,
wherein the vehicle component is configured as a traction battery of the motor vehicle.
